(19) United States
(12) Patent Application Publication
(10) Pub. No.: US 2025/0025790 A1
(43) Pub. Date: Jan. 23, 2025

(54) METHOD AND APPARATUS FOR ISSUING VIRTUAL ITEM, COMPUTER DEVICE, AND STORAGE MEDIUM

(71) Applicant: Tencent Technology (Shenzhen) Company Limited, Shenzhen (CN)

(72) Inventor: Qiankun Liang, Shenzhen (CN)

(21) Appl. No.: 18/909,108

(22) Filed: Oct. 8, 2024

Related U.S. Application Data
(63) Continuation of application No. PCT/CN2023/123203, filed on Oct. 7, 2023.

(30) Foreign Application Priority Data
Nov. 15, 2022 (CN) 202211428457.3

(51) Int. Cl. A63F 13/69; A63F 13/54; A63F 13/792

(52) U.S. Cl. CPC A63F 13/69; A63F 13/54; A63F 13/792

(57) ABSTRACT

In an electronic game environment, issuing a virtual item may include: in a case that a target round in a game battle ends, displaying an item auction interface having a plurality of accounts participating in the game battle and a virtual item that can be used in a subsequent round; in a case that an auction behavior of a first account is unlocked, displaying an auction process of the virtual item, the auction behavior being unlocked in a case that a ranking of battle points of the first account is not higher than rankings of battle points of a first target quantity of accounts, and the plurality of accounts being sorted in ascending order of battle points; and indicating, in a case that it is determined, based on the auction process, that the first account succeeded in an auction, issuance of the virtual item to the first account.

### CROSS-REFERENCE TO RELATED APPLICATIONS

This application is a continuation application of PCT Application PCT/CN2023/123203, filed Oct. 7, 2023, which claims priority to Chinese Patent Application No. 202211428457.3 filed on Nov. 15, 2022, each entitled “METHOD AND APPARATUS FOR ISSUING VIRTUAL ITEM, COMPUTER DEVICE, AND STORAGE MEDIUM”, and each of which is incorporated herein by reference in its entirety.

### FIELD

Aspects described herein relate to the field of computer technologies, and in particular, to a method and an apparatus for issuing a virtual item, a computer device, and a storage medium.

### BACKGROUND

With the rapid development of computer technologies, there are more types of electronic games. In an electronic game, different accounts may have a game battle with each other. For example, each account may purchase a respective virtual item, and engage in a battle with another account by using the virtual item.

### SUMMARY

Aspects described herein provide a method, computer device, storage medium, and an apparatus for issuing a virtual item, and can improve interaction between accounts. Example aspects including the following.

According to an aspect, a method for issuing a virtual item is provided. The method includes:
in a case that a target round in a game battle ends, displaying an item auction interface, the item auction interface including a plurality of accounts participating in the game battle and a virtual item that can be used in a subsequent round, the plurality of accounts including a first account, and the first account being a local account;
in a case that an auction behavior of the first account is unlocked, displaying an auction process of the virtual item based on an auction operation on the virtual item, the auction behavior being unlocked in a case that a ranking of battle points of the first account is not higher than rankings of battle points of a first target quantity of accounts, the plurality of accounts being sorted in ascending order of battle points, and the first target quantity being a quantity of accounts allowed to participate in an auction; and
receiving, in a case that it is determined, based on the auction process, that the first account succeeds in the auction, the virtual item issued to the first account.

According to another aspect, a method for issuing a virtual item is provided. The method includes:
in a case that a target round in a game battle ends, determining a plurality of accounts participating in the game battle and a virtual item that can be used in a subsequent round;
in a case that a ranking of battle points of an account is not higher than rankings of battle points of a first target quantity of accounts, unlocking an auction behavior of the account, the plurality of accounts being sorted in ascending order of battle points, and the first target quantity being a quantity of accounts allowed to participate in an auction; and
notifying a terminal of the account of the virtual item and first indication information, the first indication information indicating whether the auction behavior of the account is unlocked.

According to another aspect, an apparatus for issuing a virtual item is provided. The apparatus includes:
an interface display module, configured to: in a case that a target round in a game battle ends, display an item auction interface, the item auction interface including a plurality of accounts participating in the game battle and a virtual item that can be used in a subsequent round, the plurality of accounts including a first account, and the first account being a local account;
an auction module, configured to: in a case that an auction behavior of the first account is unlocked, display an auction process of the virtual item based on an auction operation on the virtual item, the auction behavior being unlocked in a case that a ranking of battle points of the first account is not higher than rankings of battle points of a first target quantity of accounts, the plurality of accounts being sorted in ascending order of battle points, and the first target quantity being a quantity of accounts allowed to participate in an auction; and
an item receiving module, configured to receive, in a case that it is determined, based on the auction process, that the first account succeeds in the auction, the virtual item issued to the first account.

According to some aspects, the interface display module may be further configured to display, in a preset region corresponding to the virtual item in descending order or ascending order of auction prices, accounts that bid for the virtual item and the corresponding auction prices, where the auction price is a quantity of virtual resources configured for bidding for the virtual item.

According to some aspects, the auction module may be configured to: in a case that the auction behavior of the first account is unlocked and an auction condition is satisfied, display the auction process based on the auction operation, where the auction condition includes at least one of the following:
the first account has not successfully bought any virtual item from a beginning of the auction;
the virtual item for which the first account bids has not been bought by any account from the beginning of the auction;
a status of the virtual item for which the first account bids is an in-auction state in a current auction round, where the virtual item corresponds to a plurality of auction rounds; and
an auction countdown has not ended, where the auction countdown is a time period between a current time point and a time point at which the auction ends.

According to some aspects, there may be a plurality of virtual items, and the apparatus may further include a determining module, configured to:
in a case that all of the plurality of virtual items are bid for, determine that the auction of the plurality of virtual items ends.

In some arrangements, there are a plurality of virtual items, and the plurality of virtual items correspond to at least one auction round. The apparatus further includes a determining module, configured to:
in a case that a current quantity of auction rounds of the plurality of virtual items is not less than a second target quantity, determine that the auction of the plurality of virtual items ends, where the second target quantity is a maximum quantity of auction rounds of the plurality of virtual items.

According to some aspects, there may be a plurality of virtual items, and the plurality of virtual items may correspond to at least one auction round. The apparatus may further include a determining module, configured to:
in a case that at least one of the virtual items has not been bid for and a current quantity of auction rounds is less than a second target quantity, enter a next auction round.

According to some aspects, the apparatus may further include a resource issuing module, configured to:
determine a total quantity of virtual resources after the auction of the virtual item ends, where the virtual resources are virtual resources indicated by a total auction price, and the total auction price is an auction price at which the virtual item is successfully bought; and
display a special issuing effect of the virtual resources, where the special issuing effect of the virtual resources represents that the virtual resources of the total quantity are issued to the plurality of accounts based on rankings of the battle points of the plurality of accounts.

According to some aspects, the interface display module may be further configured to display prompt information on the item auction interface, where the prompt information is configured for prompting a first virtual item and a second virtual item, the first virtual item is a virtual item for which the first account can bid currently, and the second virtual item is a virtual item for which the first account cannot bid currently.

According to some aspects, there may be a plurality of virtual items. The item receiving module may be further configured to: after the auction of the plurality of virtual items ends, in a case that there is a virtual item that is not bid for and the first account does not successfully buy any virtual item, receive the virtual item that is not bid for and that is issued to the first account.

According to some aspects, the apparatus further includes:
a countdown module, configured to: in response to that the auction countdown ends, in a case that the virtual item is bid for by the plurality of accounts, enter an overtime countdown of the virtual item, where the auction countdown is the time period between the current time point and the time point at which the auction ends.

Within the overtime countdown of the virtual item, any account that bids for the virtual item may be allowed to change an auction price for bidding for the virtual item.

According to some aspects, the countdown module may be further configured to:
within the overtime countdown of the virtual item, in a case that any account changes the auction price for bidding for the virtual item, reset the overtime countdown of the virtual item.

According to some aspects, the apparatus may further include:
a module for displaying prompt information, configured to: in a case that the first account has completed the target round, but another account has not completed the target round, display auction prompt information, where the auction prompt information is configured for prompting that the auction of the virtual item is to start.

According to another aspect, an apparatus for issuing a virtual item is provided. The apparatus includes:
a first determining module, configured to: in a case that a target round in a game battle ends, determine a plurality of accounts participating in the game battle and a virtual item that can be used in a subsequent round;
an unlocking module, configured to: in a case that a ranking of battle points of an account is not higher than rankings of battle points of a first target quantity of accounts, unlock an auction behavior of the account, the plurality of accounts being sorted in ascending order of battle points, and the first target quantity being a quantity of accounts allowed to participate in an auction; and
an information transmitting module, configured to notify a terminal of the account of the virtual item and first indication information, the first indication information indicating whether the auction behavior of the account is unlocked.

According to some aspects, the apparatus further includes:
an information receiving module, configured to receive at least one piece of auction information transmitted by the terminal of the account, where the auction information indicates the virtual item for which the account bids and an auction price for bidding for the virtual item; and
an item issuing module, configured to issue, based on the auction information, the virtual item to an account that bids a highest auction price.

According to some aspects, the apparatus further includes:
a second determining module, configured to determine a total quantity of virtual resources after the auction of the virtual item ends, where the virtual resources are virtual resources indicated by a total auction price, and the total auction price is an auction price at which the virtual item is successfully bought; and
a resource issuing module, configured to issue the virtual resources of the total quantity to the plurality of accounts based on rankings of the battle points of the plurality of accounts.

According to some aspects, there may be a plurality of virtual items, and the apparatus further includes:
an item issuing module, configured to: after the auction of the plurality of virtual items ends, in a case that there is a virtual item that is not bid for and there is an account that does not successfully buy any virtual item, issue the virtual item that is not bid for to the account that does not successfully buy any virtual item.

According to some aspects, there may be a plurality of virtual items, and the apparatus further includes a third determining module, configured to:
in a case that all the plurality of virtual items are bid for, transmit an auction end notification to terminals of the plurality of accounts, where the auction end notification indicates that the auction of the plurality of virtual items ends.

According to some aspects, there may be a plurality of virtual items, and the plurality of virtual items correspond to at least one auction round. The apparatus further includes a third determining module, configured to:
in a case that a current quantity of auction rounds of the plurality of virtual items is not less than a second target quantity, transmit an auction end notification to terminals of the plurality of accounts, where the second target quantity is a maximum quantity of auction rounds of the plurality of virtual items.

According to some aspects, there may be a plurality of virtual items, and the plurality of virtual items correspond to at least one auction round. The apparatus further includes a third determining module, configured to:
in a case that at least one of the virtual items has not been bid for and a current quantity of auction rounds is less than a second target quantity, transmit an auction continuation notification to terminals of the plurality of accounts, where the auction continuation notification indicates to enter a next auction round.

According to another aspect, a computer device is provided. The computer device may include a processor and a memory. The memory may have at least one computer program stored therein, and the at least one computer program may be loaded and executed by the processor to implement operations performed in a method for issuing a virtual item described in the foregoing aspects.

According to another aspect, a computer-readable storage medium may be provided.

The computer-readable storage medium may have at least one computer program stored therein, and the at least one computer program is loaded and executed by a processor to implement operations performed in the method for issuing a virtual item described in the foregoing aspects.

According to another aspect, a computer program product is provided, including a computer program. The computer program may be loaded and executed by a processor to implement operations performed in a method for issuing a virtual item described in the foregoing aspects.

According to one or more aspects described herein, after the target round in the game battle ends, an auction stage of the virtual item may be entered, to provide the plurality of accounts participating in the game battle with the virtual item that can be used in the subsequent round. The plurality of accounts may compete for the virtual item in an auction manner. In addition, an auction behavior of an account may be unlocked based on a current ranking of battle points of the account. When the ranking of the battle points of the account is lower, a probability that the auction behavior of the account is unlocked may be greater. Therefore, an auction qualification may be preferentially opened to an account with fewer battle points, to coordinate a battle capability of each account. In some arrangements, the virtual resources may be issued to the accounts in an auction environment, so that there is a competition relationship between the accounts in a process of issuing the virtual item, to help mobilize the accounts to participate in the auction, and improve interactivity between the accounts.

### BRIEF DESCRIPTION OF THE DRAWINGS

FIG. 1 is a schematic diagram of an example implementation environment according to one or more aspects described herein.

FIG. 2 is a flowchart of an example method for issuing a virtual item according to one or more aspects described herein.

FIG. 3 is a flowchart of another example method for issuing a virtual item according to one or more aspects described herein.

FIG. 4 is a flowchart of another example method for issuing a virtual item according to one or more aspects described herein.

FIG. 5 is a schematic diagram of an example interface of a game battle according to one or more aspects described herein.

FIG. 6 is a schematic diagram of an example item auction interface according to one or more aspects described herein.

FIG. 7 is a schematic diagram of another example item auction interface according to one or more aspects described herein.

FIG. 8 is a schematic diagram of another example item auction interface according to one or more aspects described herein.

FIG. 9 is a flowchart of another example method for issuing a virtual item according to one or more aspects described herein.

FIG. 10 is a schematic diagram of an example resource issuing interface according to one or more aspects described herein.

FIG. 11 is a flowchart of another example method for issuing a virtual item according to one or more aspects described herein.

FIG. 12 is a flowchart of another example method for issuing a virtual item according to one or more aspects described herein.

FIG. 13 is a flowchart of another example method for issuing a virtual item according to one or more aspects described herein.

FIG. 14 is a schematic diagram of a structure of an example apparatus for issuing a virtual item according to one or more aspects described herein.

FIG. 15 is a schematic diagram of a structure of another example apparatus for issuing a virtual item according to one or more aspects described herein.

FIG. 16 is a schematic diagram of a structure of another example apparatus for issuing a virtual item according to one or more aspects described herein.

FIG. 17 is a schematic diagram of a structure of another example apparatus for issuing a virtual item according to one or more aspects described herein.

FIG. 18 is a schematic diagram of a structure of an example terminal according to one or more aspects described herein.

FIG. 19 is a schematic diagram of a structure of an example server according to one or more aspects described herein.

### DETAILED DESCRIPTION

To make objects, technical solutions, and advantages of aspects described herein clearer, aspects are further described in detail below with reference to the accompanying drawings.

Terms such as “first”, “second”, and the like used herein may be configured for describing various concepts in this specification. However, unless otherwise specified, the concepts are not limited by the terms. The terms are merely intended to distinguish one concept from another concept. For example, without departing from the scope of this application, a first account may be referred to as a second account, and similarly, the second account may be referred to as the first account.

“At least one” means one or more. For example, at least one account may refer to a number of accounts, where that number is any integer greater than or equal to one, such as one account, two accounts, or three accounts. “A plurality of” refers to two or more. For example, a plurality of accounts may refer to a number of accounts, where that number is any integer greater than or equal to two, such as two accounts or three accounts. “Each” refers to each of at least one. For example, each account refers to each of a plurality of accounts. If the plurality of accounts are three accounts, each account refers to each of the three accounts.

In aspects described herein, relevant data such as user information is involved. When the foregoing aspects are applied to a specific product or technology, user permission or consent needs to be obtained, and collection, use, and processing of the relevant data need to comply with relevant laws, regulations, and standards of relevant countries and regions.

To improve fun during an electronic game battle, virtual items may be randomly issued to accounts, and each account may subsequently use the randomly obtained virtual items to engage in battle. However, in this scenario, each account is limited to receiving only the virtual item issued to that account. A process of receiving the virtual item by each account is independent of each other and does not affect each other. As a result, interactivity between the accounts in the process of issuing the virtual items is low.

The game battles described herein may be an auto chess game or battle. Auto chess games or battles are an in-game trading virtual-object multi-player round-based battle game. The game battle includes a plurality of players, with each player occupying a chessboard or chess-like board. Each round of the game battle may include a preparation stage and a battle stage. In the preparation stage, a user may purchase a virtual object in a virtual store, and deploy an owned virtual object on the chessboard. In the battle phase, lineups of virtual objects of two parties (e.g., accounts or players) in the battle are locked, and the virtual objects of the two parties automatically battle on the chessboard until all the virtual objects of one party are defeated. A player whose virtual objects are all defeated is considered a defeated party in that round, and a health value may be deducted from that party. Then, a new opponent may be matched among the plurality of players in the game battle, and a next round may be performed. A player is eliminated when the player's health value is not greater than zero. In some examples, only one last remaining or surviving player may win the game battle.

In the following description, a scene in an electronic game is used as an example. A user performs an operation on a terminal in advance to initialize and/or configure the game. For example, after detecting the operation of the user, the terminal may download a game configuration file of the electronic game. The game configuration file may include an application program, interface display data, data of a virtual scene, or the like of the electronic game, so that the user invokes the game configuration file when the user logs in to the electronic game on the terminal, to render and display an interface of the electronic game. The user may perform a touch operation on the terminal. After detecting the touch operation, the terminal may determine game data corresponding to the touch operation, and render and display the game data. The game data may include data of a virtual scene, behavioral data of a virtual object in the virtual scene, and the like.

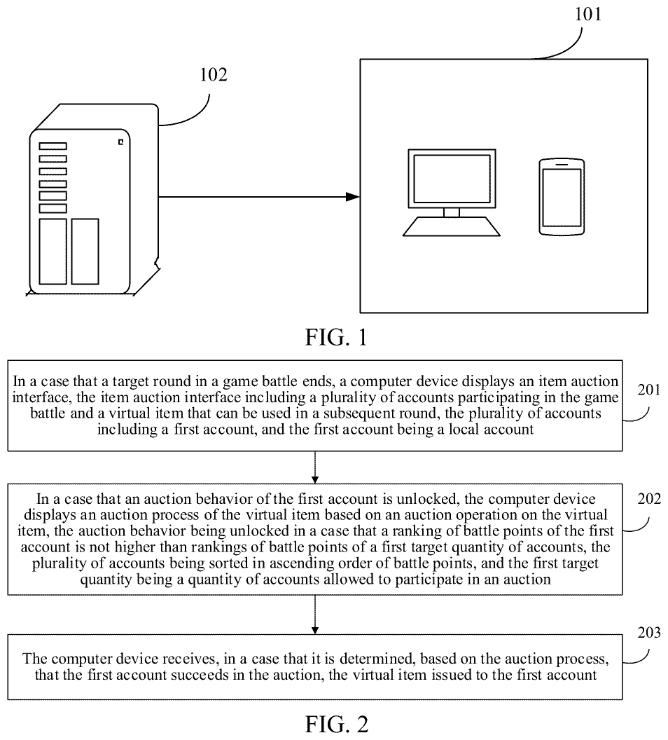

FIG. 1 is a schematic diagram of an example implementation environment according to one or more aspects described herein. As shown in FIG. 1, the implementation environment includes a terminal 101 and a server 102. The terminal 101 and the server 102 may be directly or indirectly connected in a wired or wireless communication manner. In FIG. 1, only an example in which the server 102 is connected to the terminal 101 is used. In addition, the server 102 can be connected to another terminal.

In some arrangements, the terminal 101 may be a smartphone, a tablet computer, a notebook computer, a desktop computer, a smart speaker, a smart television, a smart watch, a hand-held portable game device, or the like, but is not limited thereto. The server 102 may be an independent physical server, a server cluster or distributed system including a plurality of physical servers, or a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

The server 102 may provide game data to the terminal 101. The terminal 101 can display a picture of a game battle based on the game data provided by the server 102, and the terminal 101 can control a virtual object based on the picture of the game battle. The server 102 may be configured to perform background processing based on the control on the virtual object by the terminal 101, and provide background support for the terminal 101.

In some arrangements, the server 102 may be a game server, the terminal 101 may run a game application provided by the server 102, and the terminal 101 may interact with the server 102 through the game application.

An example method for issuing a virtual item can be applied to a scene of an electronic game.

For example, a game battle may include a plurality of players. The player may purchase a virtual object in a virtual store, and perform a plurality of rounds (e.g., of battle) with another player by using the purchased virtual object. After a current round ends, an auction stage may be entered into by using methods and processes described herein. In the auction stage, the plurality of players may be provided with a to-be-auctioned virtual item, where the virtual item may be used in a subsequent round. In addition, an auction behavior may be preferentially unlocked for a player with fewer battle points based on rankings of battle points of the plurality of players, so that the player with fewer battle points has priority in an auction qualification, and an opportunity that the player currently at a disadvantage succeeds in an auction is enhanced. After the player successfully buys the virtual item, the player may use the virtual item in the subsequent round, resulting in a method and process for issuing the virtual item to the player through the auction.

FIG. 2 is a flowchart of an example method for issuing a virtual item according to one or more aspects described herein. This examples method may be performed by a computer device. Referring to FIG. 2, the method includes the following operations.

201: In a case that a target round in a game battle ends, the computer device displays an item auction interface, the item auction interface including a plurality of accounts participating in the game battle and a virtual item that can be used in a subsequent round, the plurality of accounts including a first account, and the first account being a local account.

The game battle may include a plurality of rounds, and the target round may be any round in the game battle. For the plurality of accounts participating in the game battle, in each round, each account may purchase a virtual object in a virtual store by using a virtual resource, and use the virtual object to engage in a battle.

The virtual resource may be a resource configured for purchasing the virtual object, increasing an available quantity of the virtual objects, and refreshing the virtual store in the game. For example, the virtual resource may be a virtual gold coin. In each round, the virtual resource may be allocated to the account. A quantity of the virtual resources allocated to the account may be a preset quantity, or the quantity of the virtual resources allocated to the account is determined based on a total quantity of virtual resources currently owned by the account. For example, the quantity of the virtual resources allocated to the account may be a preset percentage of the total quantity of the virtual resources currently owned by the account. In some examples, in a case that an account wins or fails in a plurality of consecutive rounds, the virtual resource may be additionally issued to the account.

The virtual object may be configured for having a battle in each round. The virtual item may be the virtual object or an item used by the virtual object. For example, the virtual item can be worn on the virtual object, to improve a battle capability of the virtual object.

After the plurality of accounts participating in the game battle all complete the target round, the computer device may display the item auction interface, and enter an auction stage for the virtual item. The virtual item obtained through the auction may be used in any round subsequent to the target round.

202: In a case that an auction behavior of the first account is unlocked, the computer device displays an auction process of the virtual item based on an auction operation on the virtual item, the auction behavior being unlocked in a case that a ranking of battle points of the first account is not higher than rankings of battle points of a first target quantity of accounts, the plurality of accounts being sorted in ascending order of battle points, and the first target quantity being a quantity of accounts allowed to participate in an auction.

The auction process of the virtual item refers to a process in which a plurality of accounts bid prices for the virtual item. For example, when the auction process of the virtual item is displayed, accounts that bid for the virtual item may be displayed, or prices bid by the accounts for the virtual item may be displayed, or an account that buys the virtual item may be displayed.

In each round, the battle points of each account may change correspondingly based on battle statuses of the plurality of accounts. For example, the battle points of the account may be equal to a current health value of the account. The plurality of accounts may be sorted in ascending order of the battle points, and the auction behavior may be unlocked for an account sorted in top first target quantity. In other words, a number of first target accounts with fewer or the fewest battle points may be allowed to participate in the auction, while other accounts not in the first target accounts might not allowed to participate in the auction.

For example, if there are eight accounts participating in the game, and a first target quantity is equal to six, only six accounts are allowed to participate in the auction at a particular time. In this case, the auction behavior is unlocked for six accounts with the fewest battle points, and the auction behavior is not unlocked for the remaining two accounts. In other words, the six accounts with the fewest battle points are allowed to participate in the auction, and the two accounts with more battle points are not allowed to participate in the auction.

In this example, after the round ends, the auction behavior may be unlocked for the account with fewest battle points. When the ranking of the battle points of the account is lower, a probability that the auction behavior of the account is unlocked may be greater. Therefore, an auction qualification is preferentially opened to the account with fewer battle points, and an opportunity of preferentially selecting and obtaining the virtual item is provided to the account with lagging battle points. This is equivalent to providing a manner of improving a battle capability to the account (or player) at a disadvantage, to coordinate a battle capability of each account, and help enhance an opportunity of comeback by the account at a disadvantage.

203: The computer device receives, in a case that it is determined, based on the auction process, that the first account succeeds in the auction, the virtual item issued to the first account.

In a case that the first account succeeds in the auction, the computer device may receive the virtual item issued to the first account, and the first account may use the virtual item in the subsequent round. For example, in a case that the virtual item is a virtual object, the first account may use the virtual object to have a battle in the subsequent round. In another example, in a case that the virtual item is virtual equipment, the first account may equip a virtual object with the virtual equipment in the subsequent round, to improve a battle capability of the virtual object.

In some examples, the virtual item may be issued in an auction manner, so that the accounts compete with each other for the virtual item, to facilitate active participation of each account in the auction, thereby introducing completely new social interaction gameplay, and improving interactivity of each account. In addition, after the auction starts, each account can select, based on a requirement of the account, whether to bid for the virtual item and a virtual item to be bid for, so that selection space of the virtual item may be expanded. In addition, because the virtual item is issued in the auction manner, the virtual item may be issued to an account that bids a high price, to ensure, to some extent, fairness of a process of issuing the virtual item.

In methods described herein, after the target round in the game battle ends, an auction stage of the virtual item may be entered, to provide the plurality of accounts participating in the game battle with the virtual item that can be used in the subsequent round. The plurality of accounts may compete for the virtual item in an auction manner. In addition, an auction behavior of an account may be unlocked based on a current ranking of battle points of the account. When the ranking of the battle points of the account is lower, a probability that the auction behavior of the account is unlocked may be greater. Therefore, an auction qualification may be preferentially opened to an account with fewer battle points, to coordinate a battle capability of each account. According to some aspects, the virtual resources may be issued to the accounts in the auction manner, so that there is a competition relationship between the accounts in a process of issuing the virtual item, to help mobilize the accounts to participate in the auction, and improve interactivity between the accounts.

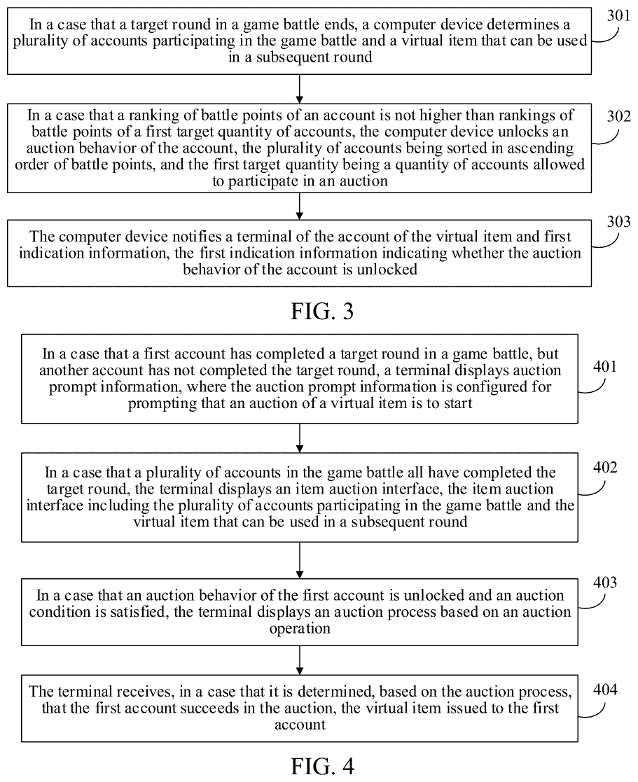

FIG. 3 is a flowchart of another method for issuing a virtual item according to one or more aspects described herein. This method may be performed by a computer device. Referring to FIG. 3, the method includes the following operations.

301: In a case that a target round in a game battle ends, the computer device determines a plurality of accounts participating in the game battle and a virtual item that can be used in a subsequent round.

The game battle includes a plurality of rounds, and the target round may be any round in the game battle. For the plurality of accounts participating in the game battle, in each round, each account may purchase a virtual object in a virtual store by using a virtual resource, and use the virtual object to have a battle. The virtual resource and the virtual item may be the same as the virtual resource and the virtual item in the foregoing operation 201. Accordingly, those details are not described herein again.

302: In a case that a ranking of battle points of an account is not higher than rankings of battle points of a first target quantity of accounts, the computer device unlocks an auction behavior of the account, the plurality of accounts being sorted in ascending order of battle points, and the first target quantity being a quantity of accounts allowed to participate in an auction.

The computer device may determine the battle points of the plurality of accounts, and rank the plurality of accounts in ascending order of the battle points, to determine a first target quantity of the accounts allowed to participate in the auction. In the case that the battle point ranking of the account is not higher than the threshold battle point ranking of the first target quantity of accounts, the auction behavior of the account may be unlocked, in other words, the account is allowed to participate in the auction. In a case that the battle point ranking of the account is higher than the threshold battle point ranking of the first target quantity of accounts, the auction behavior of the account might not be unlocked for that account. In other words, the account is not allowed to participate in the auction.

For example, when a quantity of the plurality of accounts participating in the game battle is not less than the first target quantity, a quantity of accounts for which the auction behavior is unlocked is equal to the first target quantity. When the quantity of the plurality of accounts participating in the game battle is less than the first target quantity, the quantity of the accounts for which the auction behavior is unlocked is the quantity of the plurality of accounts. In other words, the auction behavior is unlocked for all the accounts participating in the game battle.

303: The computer device notifies a terminal of the account of the virtual item and first indication information, the first indication information indicating whether the auction behavior of the account is unlocked.

After determining the to-be-auctioned virtual item, the accounts participating in the auction, and the first indication information corresponding to each account, the computer device may respectively notify the terminal of the account of the virtual item and the first indication information. In a case that the auction behavior of the account is unlocked, the terminal may allow the account to bid for the virtual item. In this case, an auction process of the virtual item may be displayed based on an auction operation on the virtual item. In a case that the auction behavior of the account is not unlocked, the terminal might not allow the account to bid for the virtual item. In this case, an auction process of the virtual item by another account may be displayed. The terminal of the account may refer to a terminal that logs in to the account.

After the target round in the game battle ends, an auction stage of the virtual item may be entered, to provide the plurality of account participating in the game battle with the virtual item that can be used in the subsequent round. The plurality of accounts may compete for the virtual item in an auction manner. In addition, an auction behavior of an account may be unlocked based on a current ranking of battle points of the account. When the battle point ranking of the account is lower, a probability that the auction behavior of the account is unlocked may be greater. Therefore, an auction qualification may be preferentially opened to an account with fewer battle points, to coordinate a battle capability of each account. According to one or more aspects, the virtual resources may be issued to the accounts in the auction manner, so that there is a competition relationship between the accounts in a process of issuing the virtual item, to help mobilize the accounts to participate in the auction, and improve interactivity between the accounts.

FIG. 4 is a flowchart of another example method for issuing a virtual item according to one or more aspects described herein. This method may be performed by a terminal. Referring to FIG. 4, the method includes the following operations.

401: In a case that a first account has completed a target round in a game battle, but another account has not completed the target round, a terminal displays auction prompt information, where the auction prompt information is configured for prompting that an auction of a virtual item is to start.

A plurality of accounts may participate in the game battle, and the plurality of accounts may include a first account. The first account may be a local account. The game battle may include a plurality of rounds. In each round, two of the plurality of accounts may engage in a battle. As a result, battle progresses of different accounts in the target round may be different. In the case that the first account has completed the target round, but another account has not completed the target round, before entering an auction stage, the first account may need to wait for all other accounts (such as the other account) to complete the target round. Therefore, the terminal may display auction prompt information, to prompt the first account that the auction of the virtual item is to start, in other words, prompt the first account to wait for another player to complete the target round before the auction of the virtual item starts.

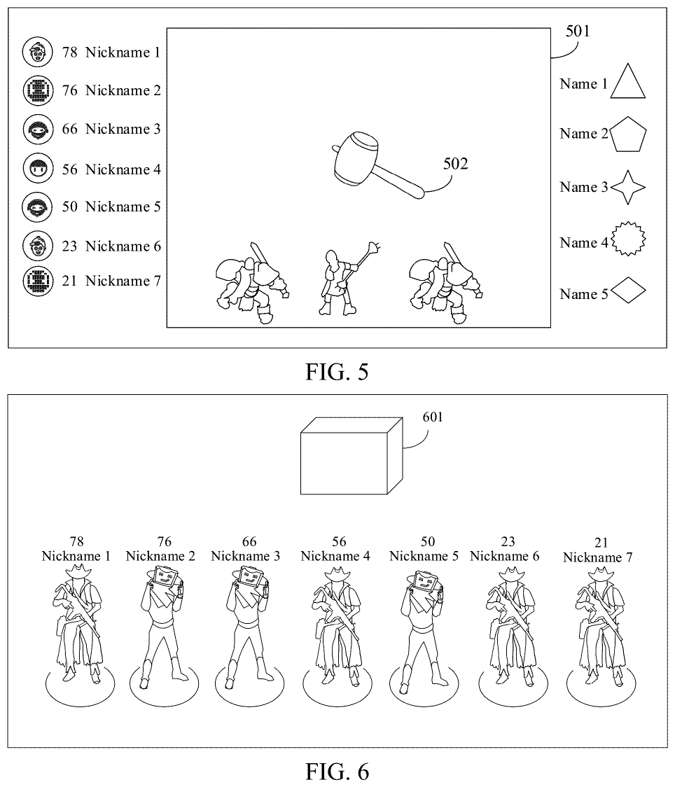

FIG. 5 is a schematic diagram of an interface of a game battle according to one or more aspects described herein. As shown in FIG. 5, avatars, battle points, and nicknames of a plurality of accounts participating in the game battle are displayed in a left region of the interface of the game battle, and names and logos of a plurality of virtual objects are displayed in a right region of the interface of the game battle. A middle region 501 of the interface of the game battle is a battle region. A virtual object of a first account is displayed in the battle region. After the first account completes a target round, a terminal displays a hammer special effect 502 in the battle region. The hammer special effect 502 may be auction prompt information, configured for prompting or otherwise notifying that an auction of a virtual item is to start.

In the case that the first account has completed the target round, but another account has not completed the target round, the auction prompt information may be displayed to prompt the first account that the auction of the virtual item is to start. Therefore, a player can be prompted to prepare for the auction, and a case that the first account does not know what is to be performed next after completing the target round can be avoided, to increase an amount of information displayed by the terminal, and help guide the player to perform interaction.

402: In a case that the plurality of accounts in the game battle all have completed the target round, the terminal displays an item auction interface, the item auction interface including the plurality of accounts participating in the game battle and the virtual item that can be used in a subsequent round.

In the case that the plurality of accounts in the game battle all have completed the target round, the terminal may determine the to-be-auctioned virtual item and the plurality of accounts participating in the game battle, and display the plurality of accounts and the virtual item on the item auction interface. The item auction interface may be configured for displaying content related to the auction.

In one or more arrangements, the terminal may display prompt information on the item auction interface. The prompt information may be configured for prompting or indicating a virtual item for which the first account can bid currently and a virtual item for which the first account cannot bid currently. In other words, the prompt information may be configured for prompting or indicating a first virtual item and a second virtual item, the first virtual item being the virtual item for which the first account can bid currently, and the second virtual item being the virtual item for which the first account cannot bid currently. For example, the terminal may set (e.g., display) the virtual item for which the first account can bid currently to a first color, and sets the virtual item for which the first account cannot bid currently to a second color (e.g., gray).

For the first account, the virtual item may include the virtual item for which the first account can bid currently and the virtual item for which the first account cannot bid currently. For example, when the virtual item for which the first account cannot bid currently includes a virtual item whose auction permission is not currently opened, no account may be allowed to bid for the virtual item. When the virtual item for which the first account cannot bid currently includes a virtual item that has been successfully bought, no account may be allowed to bid for the virtual item again. In other words, all accounts may be prevented or barred from bidding on the virtual item again. When the first account successfully buys any virtual item, all other virtual items may be virtual items for which the first account cannot bid currently. However, another account may be allowed to bid for the virtual items for which the first account cannot bid currently, or another account may be allowed to bid for the virtual item bid for by the first account. In other words, one account may be allowed to bid for at most one virtual item. In a case that the auction behavior of the first account is not unlocked, all virtual items may be correspond to the virtual item for which the first account cannot bid currently. However, another account for which the auction behavior is unlocked can bid for one or more of the virtual items.

FIG. 6 is a schematic diagram of an example item auction interface according to one or more aspects described herein. As shown in FIG. 6, an auction mark 601 is displayed on the item auction interface. The item auction interface further displays virtual images, battle points, and nicknames of a plurality of accounts. After all the accounts enter the item auction interface, a terminal displays to-be-auctioned virtual item on the item auction interface.

In one example, after an auction stage is entered, the terminal may determine a quantity of virtual items in a current auction. The quantity of virtual items may be determined based on first configuration information. The first configuration information may be configured for configuring the quantity of to-be-auctioned virtual items based on a quantity of the accounts participating in a game battle. An example first configuration information is shown in Table 1 below.

TABLE 1

| Quantity of accounts | Quantity of virtual items |
|---|---|
| 8 | 8 |
| 7 | 8 |
| 6 | 8 |
| 5 | 6 |
| 4 | 6 |
| 3 | 4 |
| 2 | 4 |
| 1 | 4 |

As shown in Table 1, the first configuration information includes a correspondence between the quantity of accounts and the quantity of virtual items. The corresponding quantity of to-be-auctioned virtual items may be determined based on the quantity of accounts currently participating in the game battle.

In some arrangements, after the auction stage is entered, the terminal may determine, based on second configuration information, a maximum quantity of auction rounds in this auction, a virtual item whose auction permission is opened, and an account for which an auction behavior is unlocked. The maximum quantity of auction rounds refers to a maximum quantity of auction rounds performed for the virtual item. An account might only be allowed to participate in the auction only after the auction behavior of the account is unlocked, and the virtual item might only be allowed to be bid for after the auction permission of the virtual item is opened. For example, second configuration information is shown in Table 2 below.

TABLE 2

| | 1^{st} auction | 2^{nd} auction | 3^{rd} auction |
|---|---|---|---|
| Unlocked state | round | round | round |
| Quantity of accounts | 5 | 8 | * |
| for which the auction | | | |
| behavior is unlocked | | | |
| Quantity of virtual | 6 | * | |
| items whose auction | | | |
| permissions are opened | | | |

The second configuration information indicates that the quantity of accounts for which the auction behavior is unlocked in the 1^{st} auction round is five, and the quantity of accounts for which the auction behavior is unlocked in the 2^{nd} auction round is eight. “*” in the 2^{nd} row and the 4^{th} column indicates that there is no 3^{rd} auction round. In the 1^{st} auction round, the quantity of virtual items whose auction permissions are opened is six. “*” in the 2^{nd} row and the 3^{rd} column indicates that auction permissions of all the virtual items in the 2^{nd} auction round are opened.

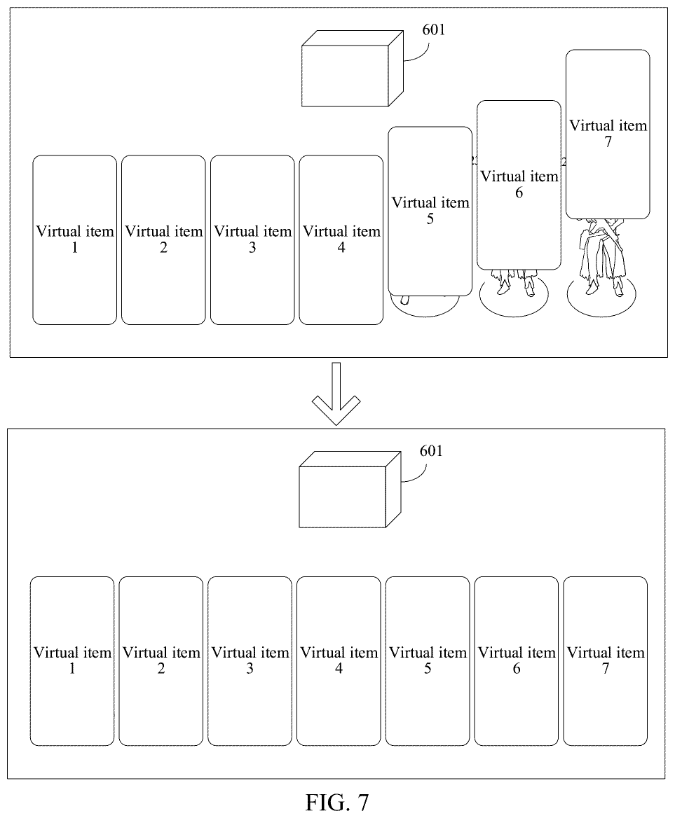

FIG. 7 is a schematic diagram of another example item auction interface according to one or more aspects described herein. As shown in FIG. 7, after determining to-be-auctioned virtual items, a terminal displays, on an item auction interface, a special effect of presenting a virtual item 1 to a virtual item 7. The virtual item 1 to the virtual item 7 cover virtual images displayed on the item auction interface.

403: In a case that the auction behavior of the first account is unlocked and an auction condition is satisfied, the terminal displays an auction process based on an auction operation.

In the case that the auction behavior of the first account is unlocked and the auction condition is satisfied, the player of the first account can perform the auction operation, and the terminal displays the auction process based on the auction operation of the first account.

The auction condition includes at least one of the following:
(1) The first account has not successfully bought any virtual item from a beginning of the auction. Each account is allowed to bid for only one virtual item. If the first account has not successfully bought any virtual item from the beginning of the auction, the first account is allowed to participate in the auction. If the first account has successfully bought any virtual item from the beginning of the auction, the first account is not allowed to continue to participate in the auction.
(2) The virtual item for which the first account bids has not been bought by any account from the beginning of the auction. Each virtual item is allowed to be bought by only one account. If the virtual item has not been successfully bought by any account from the beginning of the auction, the first account is allowed to bid for the virtual item. If the virtual item has been successfully bought by any account from the beginning of the auction, the first account is not allowed to bid for the virtual item again.
(3) A status of the virtual item for which the first account bids is an in-auction state in a current auction round, where the virtual item corresponds to a plurality of auction rounds. The terminal may set an auction permission for the virtual item. In a case that the auction permission of the virtual item is opened, the virtual item is in the in-auction state, and the first account is allowed to bid for the virtual item. In a case that the auction permission of the virtual item is not opened, the virtual item is in a non-auction state, and the first account is not allowed to bid for the virtual item.
(4) An auction countdown has not ended, where the auction countdown is a time period between a current time point and a time point at which the auction ends. When the auction countdown has not ended, the current time point has not reached the time point at which the auction ends, and the first account is allowed to bid. When the auction countdown has ended, the current time point has reached the time point at which the auction ends, and the first account is not allowed to bid.

In a possible implementation, the terminal displays, in a preset region corresponding to the virtual item in descending order or ascending order of auction prices, accounts that bid for the virtual item and the corresponding auction prices, where the auction price is a quantity of virtual resources configured for bidding for the virtual item. A quantity of the accounts that bid for the virtual item is one or more. When only one account bids for the virtual item, the account and an auction price corresponding to the account are displayed. When a plurality of accounts bid for the virtual item, the plurality of accounts and an auction price corresponding to each account are displayed.

In the auction stage, the virtual item may be bid for by at least one account. The terminal determines the at least one account that bids for the virtual item and an auction price from each account, and displays the at least one account and the corresponding auction price in a value order of the auction prices, to help the player quickly determine the account that bids for the virtual item, and intuitively sense the auction price from each account, so that the player adjusts the auction price based on a requirement in time.

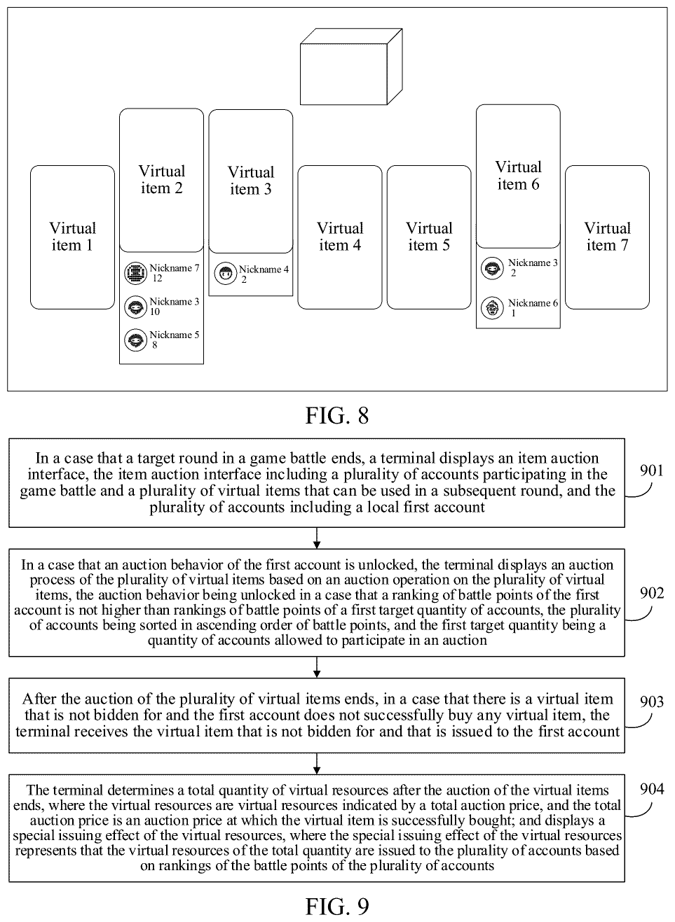

FIG. 8 is a schematic diagram of another item auction interface according to one or more aspects described herein. As shown in FIG. 8, three accounts bid for a virtual item 2. A terminal displays, in a region below the virtual item 2, the three accounts that bid for the virtual item 2 and auction prices corresponding to the accounts in descending order of the auction prices. Two accounts bid for a virtual item 6. The terminal displays, in a region below the virtual item 6, the two accounts that bid for the virtual item 6 and auction prices corresponding to the accounts in descending order of the auction prices. One account bids for a virtual item 3. The terminal displays, in a region below the virtual item 3, the account that bids for the virtual item 3 and an auction price corresponding to the account.

In one example, in response to the end of the auction countdown, in a case that the virtual item is bid for by the plurality of accounts, the terminal may enter an overtime countdown of the virtual item, where the auction countdown is the time period between the current time point and the time point at which the auction ends. Within the overtime countdown of the virtual item, any account that bid for the virtual item may be allowed to change an auction price for bidding for the virtual item.

The overtime countdown may be a time period between the current time point and a new time point at which the auction ends. The new time point at which the auction ends may be a time point at which the account that bids for the virtual item is no longer allowed to change the auction price.

After the auction countdown ends, in the case that the virtual item is bid for by the plurality of accounts, if the virtual item is directly issued to an account that bid a highest auction price, an account that bid a low price fails in the auction, which may result in poor flexibility. Therefore, in some arrangements, after the auction countdown ends, in the case that the virtual item is bid for by the plurality of accounts, the overtime countdown is further provided. Within the overtime countdown, each account can select, based on a status of the current auction price and a requirement of the account, whether to change the auction price, so that an opportunity of continuing to compete for the virtual item is provided for an account that initially bid a low price in the auction, and flexibility of bidding for the virtual item is improved.

In some examples, within the overtime countdown of the virtual item, in a case that any account changes the auction price for bidding for the virtual item, the overtime countdown of the virtual item may be reset.

In one example, within the overtime countdown, each time an account changes the auction price, the overtime countdown of the virtual item may be reset. In other words, each time an account changes the auction (e.g., bid) price, an opportunity of changing the auction price continues to be provided for each account, so that fairness of bidding for the virtual item is improved.

For example, an initial auction countdown may be 30 seconds. After the 30 seconds ends, if the virtual item is bid for by the plurality of accounts, the overtime countdown may be entered or started. The overtime countdown may be 5 seconds. Within the 5 seconds, each account can select, based on the status of the current auction price and the requirement of the account, whether to change its auction or bid price. Each time any account changes its auction or bid price within the overtime countdown, the overtime countdown may be entered again or restarted, in other words, the countdown may be reset to 5 seconds again.

In one or more arrangements, there may be three cases or scenarios for the virtual item in the auction stage. In a first case, the virtual item is not bid for by any account. In this case, after the auction countdown ends, the virtual item enters a next auction round or enters a bought-in stage. In a second case, the virtual item is bid for by one account during the auction stage. In this case, after the auction countdown ends, the virtual item is directly issued to the account. In a third case, the virtual item is bid for by a plurality of accounts during the auction stage. In this case, after the auction countdown ends, the overtime countdown is entered. If an account changes the auction price within the overtime countdown, the overtime countdown is reset. The virtual item is issued to an account that bids a highest auction price (i.e., has the highest bid) at the time the overtime countdown ends.

404: The terminal receives, in a case that it is determined, based on the auction process, that the first account succeeds in the auction, the virtual item issued to the first account.

In a case that it is determined, based on the auction process, that only the first account bid for the virtual item, or the first account bid a highest auction price for the virtual item, the terminal receives the virtual item issued to the first account. The first account may use the virtual item in a subsequent round.

In some arrangements, there may be a plurality of virtual items, and the plurality of virtual items correspond to at least one auction round. After the terminal receives, in the case that it is determined, based on the auction process, that the first account succeeds in the auction, the virtual item issued to the first account, the following three cases may be included.

First case: In a case that all the plurality of virtual items are bid on, the terminal determines that the auction of the plurality of virtual items ends.

If all the plurality of virtual items are bid on after the current auction round ends, it is determined that the auction of the plurality of virtual items ends, in other words, a next auction round is not entered.

Second case: In a case that a current quantity of auction rounds of the plurality of virtual items is not less than a second target quantity, the terminal determines that the auction of the plurality of virtual items ends, where the second target quantity is a maximum quantity of auction rounds of the plurality of virtual items.

If the current quantity of auction rounds is not less than the second target quantity, in other words, the current quantity of auction rounds has already reached the maximum allowed quantity of auction rounds of the plurality of virtual items, regardless of whether there is a virtual item that has not been bid on, it is determined that the auction of the plurality of virtual item ends, in other words, a next auction round is not entered. If there is currently a virtual item that is not bid on, the virtual item enters a bought-in stage.

Third case: In a case that at least one of the virtual items has not been bid on and a current quantity of auction rounds is less than a second target quantity, the terminal enters a next auction round.

If there is currently a virtual item that has not been bid for, and the current quantity of auction rounds has not reached a maximum quantity of auction rounds, the next auction round is entered. A virtual item auctioned in the next auction round is the virtual item that has not been bid for in the plurality of virtual items.

In such arrangements, the plurality of auction rounds and a quantity of accounts for which the auction behavior is unlocked in each auction round may be configured so that the auction behavior can be controlled to be preferentially unlocked for an account with fewer battle points, and the auction behavior is unlocked for an account with more battle points in a deferred manner. Therefore, an opportunity of preferential treatment (e.g., an advantage) in the auction is provided for the account at a disadvantage, and flexibility of bidding for the virtual item is improved.

According to aspects described herein, after the target round in the game battle ends, an auction stage of the virtual item may be entered, to provide the plurality of accounts participating in the game battle with an opportunity to acquire the virtual item that can be used in the subsequent round. The plurality of accounts may compete for the virtual item in an auction manner. In addition, an auction behavior (e.g., bidding ability) of an account may be unlocked based on a current ranking of battle points of the account. When the ranking of the battle points of the account is lower, a probability that the auction behavior of the account is unlocked may be greater. Therefore, an auction qualification may be preferentially opened to an account with fewer battle points, to coordinate and manage a battle capability of each account. In some arrangements, the virtual resources may be issued to the accounts in the auction manner, so that there is a competitive relationship between the accounts in a process of issuing the virtual item, to help mobilize the accounts to participate in the auction (e.g., help increase activity and engagement of the players), and improve interactivity between the accounts.

FIG. 9 is a flowchart of another example method for issuing a virtual item according to one or more aspects described herein. This method may be performed by a terminal. Referring to FIG. 9, the method includes the following operations.

901: In a case that a target round in a game battle ends, a terminal displays an item auction interface, the item auction interface including a plurality of accounts participating in the game battle and a plurality of virtual items that can be used in a subsequent round, and the plurality of accounts including a local first account.

902: In a case that an auction behavior of the first account is unlocked, the terminal displays an auction process of the plurality of virtual items based on an auction operation on the plurality of virtual items, the auction behavior being unlocked in a case that a ranking of battle points of the first account is not higher than rankings of battle points of a first target quantity of accounts, the plurality of accounts being sorted in ascending order of battle points, and the first target quantity being a quantity of accounts allowed to participate in an auction.

Operation 901 and operation 902 are similar to the foregoing operation 201 and operation 202 and the foregoing operation 402 and operation 403. Accordingly, those details are not described here again.

903: After the auction of the plurality of virtual items ends, in a case that there is a virtual item that is not bid for and the first account does not successfully buy any virtual item, the terminal receives the virtual item that is not bid for and that is issued to the first account.

If there is the virtual item that is not bid for when the auction of the plurality of virtual items ends, the virtual item that is not bid for may enter a bought-in stage. If the first account does not successfully buy any virtual item in the auction stage, the first account may enter the bought-in stage. For example, the first account might not buy any virtual item because the first account does not perform the auction operation. Alternatively, the first account might not buy any virtual item because the price bid by the first account is lower than a price bid by another account. In the bought-in stage, the terminal receives the virtual item that is not bid for.

In other words, in the bought-in stage, the virtual item that is not bid for may be issued to the account that did not buy any virtual item. In one example, in a case that there are a plurality of virtual items that are not bid for and there are a plurality of accounts that did not buy any virtual item, the plurality of virtual items that are not bid for may be randomly issued to the plurality of accounts that did not buy any virtual item.

904: The terminal determines a total quantity of virtual resources after the auction of the virtual items ends, where the virtual resources are virtual resources indicated by a total auction price, and the total auction price is an auction price at which the virtual item is successfully bought; and displays a special issuing effect of the virtual resources, where the special issuing effect of the virtual resources represents that the virtual resources of the total quantity are issued to the plurality of accounts based on rankings of the battle points of the plurality of accounts.

The auction price of each virtual item may refer to an auction price at which the virtual item is successfully bought. The total auction price at which the virtual item is successfully bought may be a sum of auction prices of the virtual item that is successfully bought. In other words, after the auction of the virtual items ends, when only one virtual item is successfully bought, the total auction price may be an auction price at which the virtual item is successfully bought. After the auction of the virtual items ends, when a plurality of virtual items are successfully bought, the total auction price may be a sum of auction prices at which the plurality of virtual items are successfully bought. The terminal determines the total quantity of the virtual resources indicated by the total auction price, and displays the special issuing effect of issuing the virtual resources of the total quantity to the plurality of accounts.

For example, the virtual resources of the total quantity may be issued to the plurality of accounts based on proportions of the rankings of the battle points of the plurality of accounts. In this case, an account whose battle points have a lower ranking may obtain fewer virtual resources, and an account whose battle points have a higher ranking may obtain more virtual resources. In other words, an account with fewer battle points might obtain fewer virtual resources, and an account with more battle points might obtain more virtual resources.

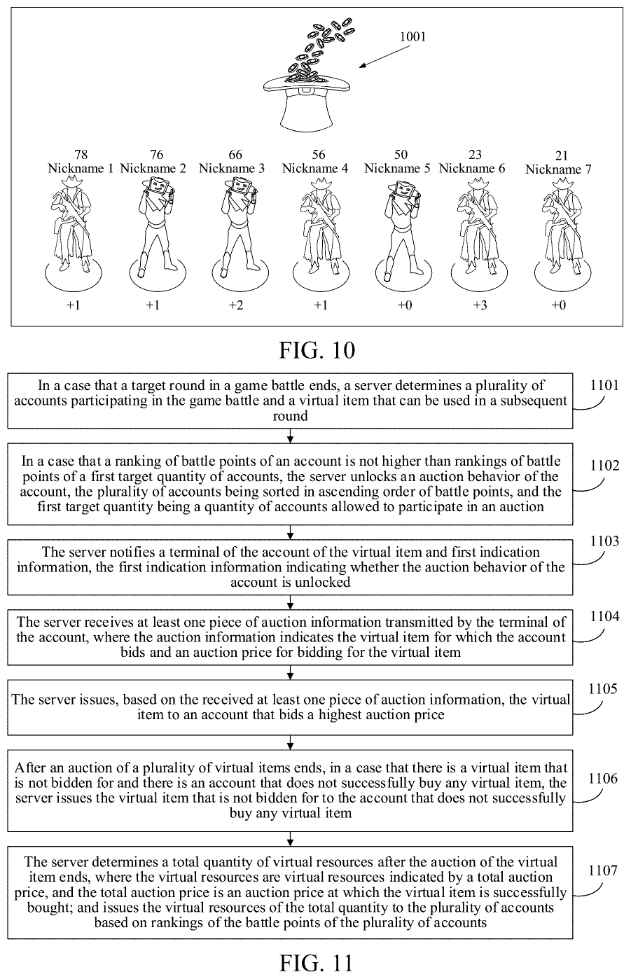

FIG. 10 is a schematic diagram of a resource issuing interface according to one or more aspects described herein. As shown in FIG. 10, a terminal displays the resource issuing interface. Virtual objects, nicknames, and battle points corresponding to a plurality of virtual accounts are displayed on the resource issuing interface. A special issuing effect 1001 of virtual resources is further displayed on the resource issuing interface. The special issuing effect 1001 is a special effect such as, for example, virtual gold coins flowing from a hat to the virtual objects corresponding to the accounts. In a process of displaying the special issuing effect 1001, a quantity of virtual resources issued to each account is displayed below the virtual object corresponding to the account.

In such an arrangement, after the auction ends, the total quantity of virtual resources may be issued to the plurality of accounts based on the rankings of the battle points of the plurality of accounts. Because the virtual resources may be returned to the account, the account may actually spend fewer virtual resources to participate in the auction, to facilitate active participation of the account in the auction. In addition, the virtual resources are issued based on the rankings of the battle points, to facilitate the account to actively compete for the battle points, thereby improving efficiency of human-computer interaction to some extent.

FIG. 11 is a flowchart of another example method for issuing a virtual item according to one or more aspects described herein. This method may be performed by a server. Referring to FIG. 11, the method includes the following operations.

1101: In a case that a target round in a game battle ends, a server determines a plurality of accounts participating in the game battle and a virtual item that can be used in a subsequent round.

1102: In a case that a ranking of battle points of an account is not higher than rankings of battle points of a first target quantity of accounts, the server unlocks an auction behavior of the account, the plurality of accounts being sorted in ascending order of battle points, and the first target quantity being a quantity of accounts allowed to participate in an auction.

1103: The server notifies a terminal of the account of the virtual item and first indication information, the first indication information indicating whether the auction behavior of the account is unlocked.

Operation 1101 to operation 1103 may be similar to the foregoing operation 301 to operation 303. Accordingly, details are not described here again.

1104: The server receives at least one piece of auction information transmitted by the terminal of the account, where the auction information indicates the virtual item for which the account bids and an auction price for bidding for the virtual item.

In a case that the auction behavior of the account is unlocked, the terminal may determine the auction information based on an auction operation on a plurality of virtual items, and transmit the auction information to the server. The server may receive the at least one piece of auction information transmitted by the terminal of the account.

1105: The server issues, based on the received at least one piece of auction information, the virtual item to an account that bids a highest auction price.

After the auction ends, the server may determine, based on the received at least one piece of auction information, a price bid by each account for the virtual item, determine the account that bid the highest auction price, and issue the virtual item to the account that bid the highest auction price.

In one or more examples, the server may issue an auction result to terminals of the plurality of accounts, where the auction result indicates the account that bid the highest auction price. Each terminal may display a special issuing effect of issuing the virtual item to the account that bid the highest auction price.

In some arrangements, there may be a plurality of virtual items, and the plurality of virtual items correspond to at least one auction round. After each auction round ends, the following three cases may be included.

First case: In a case that all the plurality of virtual items are bid for, the server may transmit an auction end notification to terminals of the plurality of accounts, where the auction end notification indicates that the auction of the plurality of virtual items has ended.

If all the plurality of virtual items are bid for after the current auction round ends, it may determine determined that the auction of the plurality of virtual items ends; in other words, a next auction round might not be entered. Therefore, the server may transmit the auction end notification to the terminals.

Second case: In a case that a current quantity of auction rounds of the plurality of virtual items is not less than a second target quantity, the server may transmit an auction end notification to terminals of the plurality of accounts, where the second target quantity is a maximum allowed quantity of auction rounds of the plurality of virtual items.

If the current quantity of auction rounds is not less than the second target quantity, in other words, the current quantity of auction rounds is already the maximum quantity of auction rounds of the plurality of virtual items, regardless of whether there is a virtual item that is not bid for, it may be determined that the auction of the plurality of virtual item ends, in other words, a next auction round might not be entered. Therefore, the server may transmit the auction end notification to the terminals. In addition, if there is currently the virtual item that is not bid for, the virtual item may enter the bought-in stage.

Third case: In a case that at least one of the virtual items has not been bid for and a current quantity of auction rounds is less than a second target quantity, the server may transmit an auction continuation notification to terminals of the plurality of accounts, where the auction continuation notification indicates to enter a next auction round.

If there is currently a virtual item that has not been bid for, and the current quantity of auction rounds has not reached a maximum quantity of auction rounds, the next auction round may be entered. Therefore, the server may transmit the auction continuation notification to the terminals. In addition, a virtual item auctioned in the next auction round may be the virtual item that has not been bid for in the plurality of virtual items.

In this arrangement, the plurality of auction rounds and a quantity of accounts for which the auction behavior is unlocked in each auction round may be configured so that the auction behavior can be controlled to be preferentially unlocked for an account with fewer battle points, and the auction behavior may be unlocked for an account with more battle points in a deferred-in-time manner. Therefore, an opportunity of preferential treatment in the auction may be provided for the account at a disadvantage, and flexibility of bidding for the virtual item is improved.

1106: After the auction of the plurality of virtual items ends, in a case that there is a virtual item that is not bid for and there is an account that does not successfully buy any virtual item, the server issues the virtual item that is not bid for to the account that does not successfully buy any virtual item.

If there is the virtual item that is not bid for when the auction of the plurality of virtual items ends, the virtual item that is not bid for enters a bought-in stage. If the account did not successfully buy any virtual item, the account may enter the bought-in stage. For example, the account might not have bought any virtual item because the account does not perform the auction operation. Alternatively, the account might not have bought any virtual item because the price bid by the account is lower than a price bid by another account. In the bought-in stage, the virtual item that is not bid for may be issued to the account that did not buy any virtual item.

In one example, in a case that there are a plurality of virtual items that are not bid for and there are a plurality of accounts that did not buy any virtual item, the plurality of virtual items that are not bid for may be randomly issued to the plurality of accounts that did not buy any virtual item.

1107: The server determines a total quantity of virtual resources after the auction of the virtual item ends, where the virtual resources are virtual resources indicated by a total auction price, and the total auction price is an auction price at which the virtual item is successfully bought; and issues the virtual resources of the total quantity to the plurality of accounts based on rankings of the battle points of the plurality of accounts.

The auction price of each virtual item may refer to an auction price at which the virtual item is successfully bought. The total auction price at which the virtual item is successfully bought may be a sum of auction prices of the virtual item that is successfully bought. In other words, after the auction of the virtual items ends, when only one virtual item is successfully bought, the total auction price may be an auction price at which the virtual item is successfully bought. After the auction of the virtual items ends, when a plurality of virtual items are successfully bought, the total auction price may be a sum of auction prices at which the plurality of virtual items are successfully bought. The server may determine the total quantity of the virtual resources indicated by the total auction price, and issue the virtual resources of the total quantity to the plurality of accounts based on the rankings of the battle points of the plurality of accounts.

According to aspects described herein, after the target round in the game battle ends, an auction stage of the virtual item may be entered, to provide the plurality of accounts participating in the game battle with an opportunity to acquire the virtual item that can be used in the subsequent round. The plurality of accounts may compete for the virtual item in an auction manner. In addition, an auction behavior of an account may be unlocked based on a current ranking of battle points of the account. When the ranking of the battle points of the account is lower, a probability that the auction behavior of the account is unlocked may be greater. Therefore, an auction qualification may be preferentially opened to an account with fewer battle points, to coordinate a battle capability of each account. In some arrangements, the virtual resources may be issued to the accounts in the auction manner, so that there is a competition relationship between the accounts in a process of issuing the virtual item, to help mobilize the accounts to participate in the auction, and improve interactivity between the accounts.

A method for issuing a virtual item provided may be divided into the following five stages. (1) Waiting stage: Wait for all accounts to end a battle round, and prompt that an auction stage is to start. (2) Transfer stage: Transfer all the accounts to an auction scene. (3) Auction stage: The account can freely bid for a lot (virtual item), and an account that bids a high price (e.g., the highest price) can obtain the corresponding lot. (4) Bought-in stage: An account that did not buy a lot in the auction stage randomly obtains, in the bought-in stage, a lot that was not bid for. (5) Bonus-share stage: Virtual resources consumed by (e.g., spent by) the accounts for the auction in the auction stage are issued to the accounts in the bonus-share stage.

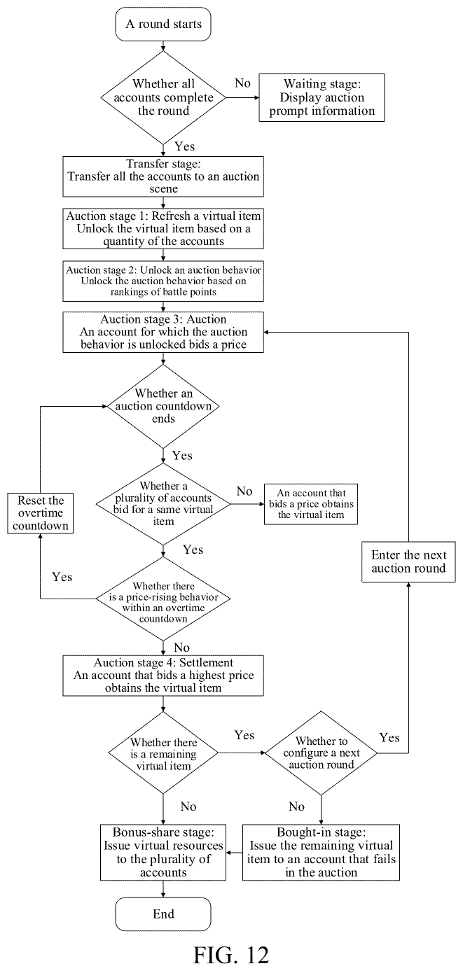

FIG. 12 is a flowchart of another example method for issuing a virtual item according to one or more aspects described herein. As shown in FIG. 12, the method includes the following operations.

Operation 1: Waiting stage: Determine whether all accounts complete a round. If “No”, waiting continues, and auction prompt information is displayed. If “Yes”, a transfer stage is entered.

Operation 2: Transfer stage: Transfer all the accounts to an auction scene, and enter an auction stage.

Operation 3: Auction stage 1: Refresh a virtual item. The virtual item is unlocked based on a quantity of accounts.

Operation 4: Auction stage 2: Unlock an auction behavior. The auction behavior is unlocked based on rankings of battle points.

Operation 5: Auction stage 3: An account for which the auction behavior is unlocked bids a price. Whether an auction countdown ends is determined. If “No”, waiting continues. If “Yes”, a quantity of accounts that bid a price is determined. Whether a plurality of accounts bid for a same virtual item is determined. If “No”, an account that bid a price directly obtains the virtual item. If “Yes”, an overtime countdown is entered, and whether an account increases its bid within the overtime countdown is determined. If “yes”, the overtime countdown is reset.

Operation 6: Auction stage 4: Settlement. Whether an account increases a bid within the overtime countdown is determined. If “No”, the settlement stage is entered, and an account that bids a highest price obtains the virtual item.

Operation 7: Determine whether there is a remaining virtual item. If “No”, a bonus-share stage is entered. If “Yes”, whether to configure a next auction round is determined.

Operation 8: Whether to configure the next auction round is determined. If “No”, a bought-in stage is entered. If “Yes”, the next auction round is entered.

Operation 9: Bought-in stage: Issue the remaining virtual item to an account that fails (e.g., did not buy a virtual item) in the auction.

Operation 10: Bonus-share stage: Issue virtual resources obtained in the auction to the plurality of accounts.

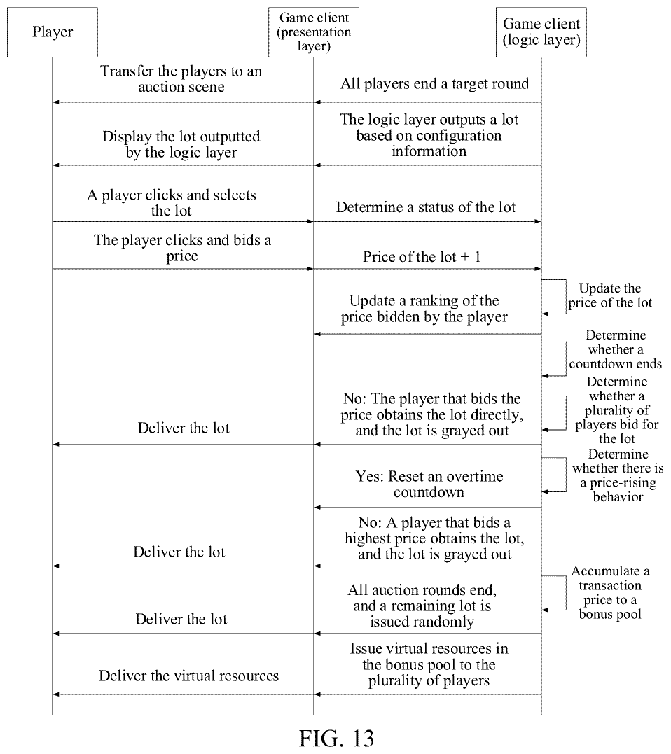

FIG. 13 is a flowchart of another example method for issuing a virtual item according to one or more aspects described herein. As shown in FIG. 13, the method includes the following operations.

Operation 1: After a logic layer of a game client determines that all players ended (e.g., completed) a target round, a presentation layer transfers the players to an auction scene.

Operation 2: The logic layer outputs a lot (virtual item) based on configuration information. The presentation layer displays the lot outputted by the logic layer.

Operation 3: The player clicks and selects the lot, the presentation layer transfers the lot selected by the player to the logic layer, and the logic layer determines a status of the lot. If the status of the lot is an “in-auction” state, the player can select the lot in a normal manner, and the presentation layer displays a special selecting effect. If the status of the lot is a “bought” state, the presentation layer controls to display a pop-up text “The lot is bought, please select another lot”.

Operation 4: The player may bid a price after selecting the lot. The presentation layer transfers price information of the players to the logic layer. The logic layer sorts prices bid by the players and returns rankings to the presentation layer. The presentation layer displays the rankings of the bid prices based on the rankings returned by the logic layer, and refreshes a bid price.

Operation 5: After an auction countdown ends, the logic layer determines whether an overtime countdown needs to be entered. If “Yes”, the presentation layer plays a special effect of the countdown, and extends a duration in which a price can be bid. If “No”, the presentation layer refreshes the status of the lot, and displays information about a player that bid a highest price and the bid price.

Operation 6: When the auction ends, the logic layer transmits a bought-in result to the presentation layer. The presentation layer refreshes information about a remaining lot that is not bid for, and displays information about a bought-in player.

Operation 7: When the auction ends, the logic layer issues virtual resources in a bonus pool to the plurality of players. The presentation layer plays an animation effect of bonus sharing based on data issued by the logic layer, and displays a quantity of the issued virtual resources.

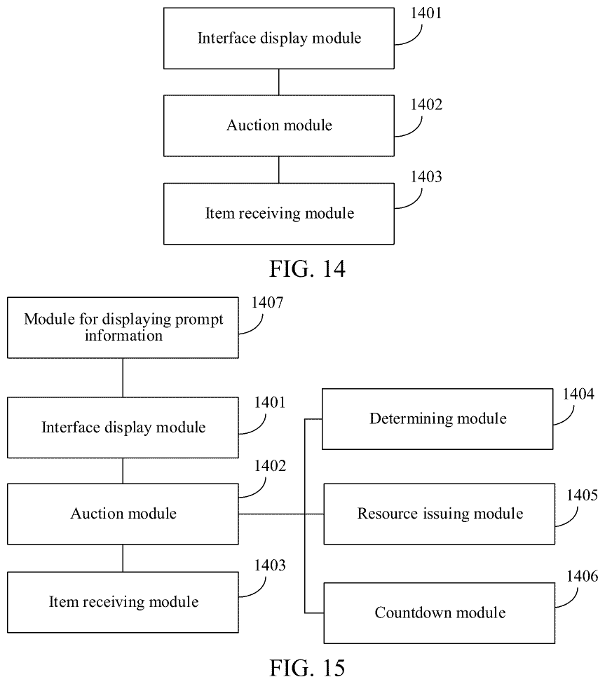

FIG. 14 is a schematic diagram of a structure of an apparatus for issuing a virtual item according to one or more aspects described herein. Referring to FIG. 14, the apparatus includes:
an interface display module 1401, configured to: in a case that a target round in a game battle ends, display an item auction interface, the item auction interface including a plurality of accounts participating in the game battle and a virtual item that can be used in a subsequent round, the plurality of accounts including a first account, and the first account being a local account;
an auction module 1402, configured to: in a case that an auction behavior of the first account is unlocked, display an auction process of the virtual item based on an auction operation on the virtual item, the auction behavior being unlocked in a case that a ranking of battle points of the first account is not higher than rankings of battle points of a first target quantity of accounts, the plurality of accounts being sorted in ascending order of battle points, and the first target quantity being a quantity of accounts allowed to participate in an auction; and
an item receiving module 1403, configured to receive, in a case that it is determined, based on the auction process, that the first account succeeds in the auction, the virtual item issued to the first account.

According to one or more aspects, after the target round in the game battle ends, an auction stage of the virtual item may be entered, to provide the plurality of account participating in the game battle with the virtual item that can be used in the subsequent round. The plurality of accounts may compete for the virtual item in an auction manner. In addition, an auction behavior of an account may be unlocked based on a current ranking of battle points of the account. When the ranking of the battle points of the account is lower, a probability that the auction behavior of the account is unlocked may be greater. Therefore, an auction qualification may be preferentially opened to an account with fewer battle points, to coordinate a battle capability of each account. In some arrangements, the virtual resources may be issued to the accounts in the auction manner, so that there is a competitive relationship between the accounts in a process of issuing the virtual item, to help mobilize the accounts to participate in the auction, and improve interactivity between the accounts.

In some arrangements, referring to FIG. 15, the interface display module 1401 may be further configured to display, in a preset region corresponding to the virtual item in descending order or ascending order of auction prices, accounts that bid for the virtual item and the corresponding auction prices, where the auction price is a quantity of virtual resources configured for bidding for the virtual item.

In some arrangements, referring to FIG. 15, the auction module 1402 may be configured to: in a case that the auction behavior of the first account is unlocked and an auction condition is satisfied, display the auction process based on the auction operation, where the auction condition includes at least one of the following:
the first account has not successfully bought any virtual item from a beginning of the auction;
the virtual item for which the first account bids has not been bought by any account from the beginning of the auction;
a status of the virtual item for which the first account bids is an in-auction state in a current auction round, where the virtual item is provided in a plurality of auction rounds; and
an auction countdown has not ended, where the auction countdown is a time period between a current time point and a time point at which the auction ends.

In some arrangements, referring to FIG. 15, there may be a plurality of virtual items, and the apparatus may further include a determining module 1404, configured to:
in a case that all the plurality of virtual items are bid for, determine that the auction of the plurality of virtual items ends.

In some arrangements, referring to FIG. 15, there may be a plurality of virtual items, and the plurality of virtual items may correspond to at least one auction round. The apparatus further includes a determining module 1404, configured to:
in a case that a current quantity of auction rounds of the plurality of virtual items is not less than a second target quantity, determine that the auction of the plurality of virtual items ends, where the second target quantity is a maximum quantity of auction rounds of the plurality of virtual items.

In some arrangements, referring to FIG. 15, there may be a plurality of virtual items, and the plurality of virtual items may correspond to at least one auction round. The apparatus further includes a determining module 1404, configured to:
in a case that at least one of the virtual items has not been bid for and a current quantity of auction rounds is less than a second target quantity, enter a next auction round.

In some arrangements, referring to FIG. 15, the apparatus may further include a resource issuing module 1405, configured to:
determine a total quantity of virtual resources after the auction of the virtual item ends, where the virtual resources are virtual resources indicated by a total auction price, and the total auction price is an auction price at which the virtual item is successfully bought; and
display a special issuing effect of the virtual resources, where the special issuing effect of the virtual resources represents that the virtual resources of the total quantity are issued to the plurality of accounts based on rankings of the battle points of the plurality of accounts.

In some arrangements, referring to FIG. 15, the interface display module 1401 may be further configured to display prompt information on the item auction interface, where the prompt information is configured for prompting a first virtual item and a second virtual item, the first virtual item being a virtual item for which the first account can bid currently, and the second virtual item being a virtual item for which the first account cannot bid currently.

In some arrangements, referring to FIG. 15, there may be a plurality of virtual items. The item receiving module 1403 may be further configured to: after the auction of the plurality of virtual items ends, in a case that there is a virtual item that is not bid for and the first account does not successfully buy any virtual item, receive the virtual item that is not bid for and that is issued to the first account.

In some arrangements, referring to FIG. 15, the apparatus may further include:
a countdown module 1406, configured to: in response to the auction countdown ending, in a case that the virtual item is bid for by the plurality of accounts, enter an overtime countdown of the virtual item, where the auction countdown is the time period between the current time point and the time point at which the auction ends.

Within the overtime countdown of the virtual item, any account that bids for the virtual item is allowed to change an auction price for bidding for the virtual item.

In some arrangements, referring to FIG. 15, the countdown module 1406 may be further configured to: within the overtime countdown of the virtual item, in a case that any account changes the auction price for bidding for the virtual item, reset the overtime countdown of the virtual item.

In some arrangements, referring to FIG. 15, the apparatus may further include:
a module 1407 for displaying prompt information, configured to: in a case that the first account has completed the target round, but another account has not completed the target round, display auction prompt information, where the auction prompt information is configured for prompting that the auction of the virtual item is to start.

The above described division of the foregoing functional modules is only an example. In some examples, the functions may be allocated to and completed by different functional modules based on a requirement. To be specific, an internal structure of a computer device is divided into different functional modules, to complete all or a part of the functions described above. In addition, an apparatus for issuing a virtual item and a method for issuing a virtual item may relate to the same concept. For a specific implementation process of the apparatus for issuing a virtual item, refer to the methods described herein. Details are not described here again.

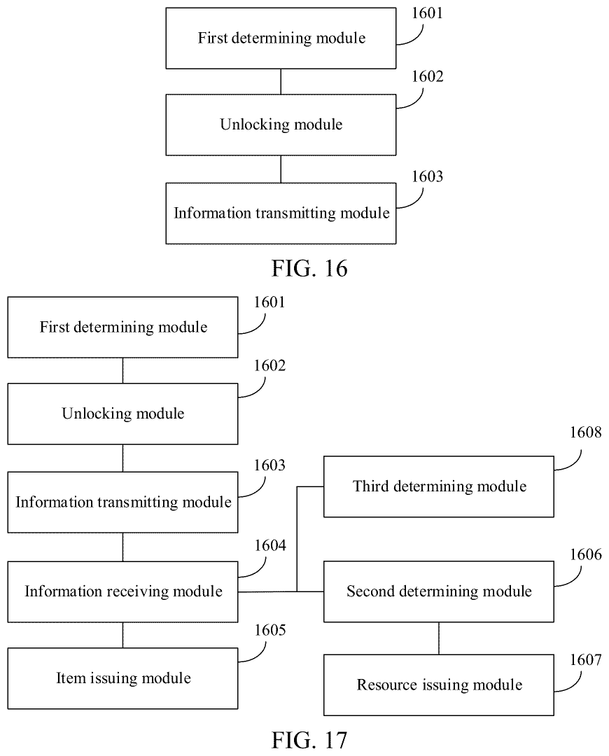

FIG. 16 is a schematic diagram of an example structure of an apparatus for issuing a virtual item according to one or more aspects described herein. Referring to FIG. 16, the apparatus includes:
a first determining module 1601, configured to: in a case that a target round in a game battle ends, determine a plurality of accounts participating in the game battle and a virtual item that can be used in a subsequent round;
an unlocking module 1602, configured to: in a case that a ranking of battle points of an account is not higher than rankings of battle points of a first target quantity of accounts, unlock an auction behavior of the account, the plurality of accounts being sorted in ascending order of battle points, and the first target quantity being a quantity of accounts allowed to participate in an auction; and
an information transmitting module 1603, configured to notify a terminal of the account of the virtual item and first indication information, the first indication information indicating whether the auction behavior of the account is unlocked.

According to one or more aspects described herein, an auction stage of the virtual item is entered, to provide the plurality of accounts participating in the game battle with the virtual item that can be used in the subsequent round. The plurality of accounts may compete for the virtual item in an auction manner. In addition, an auction behavior of an account may be unlocked based on a current ranking of battle points of the account. When the ranking of the battle points of the account is lower, a probability that the auction behavior of the account is unlocked may be greater. Therefore, an auction qualification may be preferentially opened to an account with fewer battle points, to coordinate a battle capability of each account. In some arrangements, the virtual resources may be issued to the accounts in the auction manner, so that there is a competition relationship between the accounts in a process of issuing the virtual item, to help mobilize the accounts to participate in the auction, and improve interactivity between the accounts.

In some arrangements, referring to FIG. 17, the apparatus further includes:
an information receiving module 1604, configured to receive at least one piece of auction information transmitted by the terminal of the account, where the auction information indicates the virtual item for which the account bids and an auction price for bidding for the virtual item; and
an item issuing module 1605, configured to issue, based on the auction information, the virtual item to an account that bids a highest auction price.

In some arrangements, referring to FIG. 17, the apparatus further includes:
a second determining module 1606, configured to determine a total quantity of virtual resources after the auction of the virtual item ends, where the virtual resources are virtual resources indicated by a total auction price, and the total auction price is an auction price at which the virtual item is successfully bought; and
a resource issuing module 1607, configured to issue the virtual resources of the total quantity to the plurality of accounts based on rankings of the battle points of the plurality of accounts.

In some arrangements, referring to FIG. 17, there are a plurality of virtual items, and the apparatus further includes:
an item issuing module 1605, configured to: after the auction of the plurality of virtual items ends, in a case that there is a virtual item that is not bid for and there is an account that did not successfully buy any virtual item, issue the virtual item that is not bid for to the account that did not successfully buy any virtual item.

In some arrangements, referring to FIG. 17, there are a plurality of virtual items, and the apparatus further includes a third determining module 1608, configured to:
in a case that all the plurality of virtual items are bid for, transmit an auction end notification to terminals of the plurality of accounts, where the auction end notification indicates that the auction of the plurality of virtual items ends.

In some arrangements, referring to FIG. 17, there may be a plurality of virtual items, and the plurality of virtual items may correspond to at least one auction round. The apparatus may further include a third determining module 1608, configured to:
in a case that a current quantity of auction rounds of the plurality of virtual items is not less than a second target quantity, transmit an auction end notification to terminals of the plurality of accounts, where the second target quantity is a maximum quantity of auction rounds of the plurality of virtual items.

In some arrangements, referring to FIG. 17, there may be a plurality of virtual items, and the plurality of virtual items may correspond to at least one auction round. The apparatus may further include a third determining module 1608, configured to:
in a case that at least one of the virtual items has not been bid for and a current quantity of auction rounds is less than a second target quantity, transmit an auction continuation notification to terminals of the plurality of accounts, where the auction continuation notification indicates to enter a next auction round.

The above division of the foregoing functional modules is only an example. In some arrangements, the functions can be allocated to and completed by different functional modules based on a requirement. To be specific, an internal structure of a computer device is divided into different functional modules, to complete all or a part of the functions described above. In addition, the apparatus for issuing a virtual item and the method for issuing a virtual item may relate to the same concept. For a specific implementation process of the apparatus for issuing a virtual item, refer to the methods described herein. Details are not described here again.

Aspects described herein provide a computer device. The computer device may include a processor and a memory. The memory may have at least one computer program stored therein, and the at least one computer program may be loaded and executed by the processor, to implement operations performed in the methods for issuing a virtual item described herein.

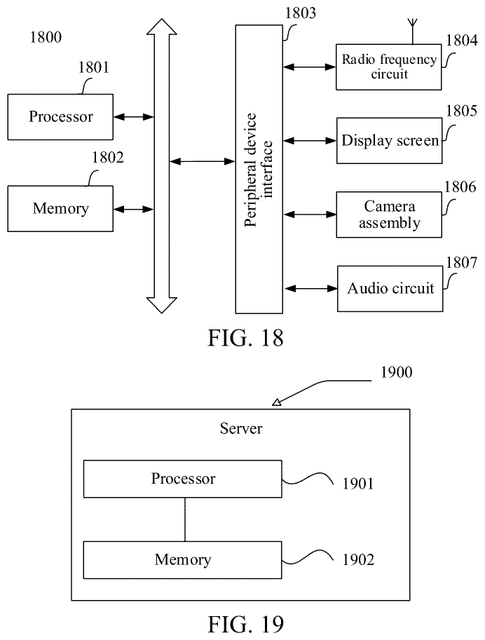

In some arrangements, the computer device is provided as a terminal. FIG. 18 is a schematic diagram of an example structure of a terminal 1800.

The terminal 1800 includes a processor 1801 and a memory 1802.

The processor 1801 may include one or more processing cores, for example, may be a four-core processor or an eight-core processor. The processor 1801 may be implemented in at least one hardware form of a digital signal processor (DSP), a field-programmable gate array (FPGA), and a programmable logic array (PLA). The processor 1801 may alternatively include a main processor and a co-processor. The main processor is a processor configured to process data in an awoken state, and is also referred to as a central processing unit (CPU). The co-processor is a low-power consumption processor configured to process data in a standby state. In some arrangements, the processor 1801 may be integrated with a graphics processing unit (GPU). The GPU is configured to render and draw content that needs to be displayed on a display screen. In some examples, the processor 1801 may further include an artificial intelligence (AI) processor. The AI processor is configured to process a computing operation related to machine learning.

The memory 1802 may include one or more computer-readable storage media. The computer-readable storage medium may be non-transient. In addition, the memory 1802 may further include a high-speed random access memory and a non-volatile memory, for example, one or more magnetic disk storage devices or flash memory devices. In some arrangements, the non-transient computer-readable storage medium in the memory 1802 is configured to store at least one computer program, and the at least one computer program is configured to be executed by the processor 1801 to implement the method for issuing a virtual item provided in the methods described herein.

In some arrangements, the terminal 1800 may further include a peripheral device interface 1803 and at least one peripheral. The processor 1801, the memory 1802, and the peripheral device interface 1803 may be connected through a bus or a signal cable. Each peripheral may be connected to the peripheral device interface 1803 through a bus, a signal cable, or a circuit board. In some arrangements, the peripheral may include at least one of a radio frequency circuit 1804, a display screen 1805, a camera assembly 1806, and an audio circuit 1807.

The peripheral device interface 1803 may be configured to connect the at least one peripheral related to input/output (I/O) to the processor 1801 and the memory 1802. In some arrangements, the processor 1801, the memory 1802, and the peripheral device interface 1803 are integrated on a same chip or circuit board. In some other arrangements, any one or two of the processor 1801, the memory 1802, and the peripheral device interface 1803 may be implemented on a single chip or circuit board. This configuration is merely an example is not limiting.

The radio frequency circuit 1804 may be configured to receive and transmit a radio frequency (RF) signal, also referred to as an electromagnetic signal. The radio frequency circuit 1804 may communicate with a communication network and another communication device by using the electromagnetic signal. The radio frequency circuit 1804 may convert an electrical signal into an electromagnetic signal for transmission, or convert a received electromagnetic signal into an electrical signal. In some arrangements, the radio frequency circuit 1804 may include an antenna system, an RF transceiver, one or more amplifiers, a tuner, an oscillator, a digital signal processor, a codec chip set, a subscriber identity module card, and the like. The radio frequency circuit 1804 may communicate with another device through at least one wireless communication protocol. The wireless communication protocol may include, but is not limited to, a metropolitan area network, generations of mobile communication networks (2G, 3G, 4G, and 5G), a wireless local area network, and/or a wireless fidelity (Wi-Fi) network. In some arrangements, the radio frequency circuit 1804 may further include a circuit related to near field communication (NFC). This configuration is merely an example and is not limiting.

The display screen 1805 may be configured to display a user interface (UI). The UI may include a graph, a text, an icon, a video, and any combination thereof. When the display screen 1805 is a touch display screen, the display screen 1805 may further have a capability of collecting a touch signal on or above a surface of the display screen 1805. The touch signal may be inputted to the processor 1801 as a control signal for processing. In this case, the display screen 1805 may be further configured to provide a virtual button and/or a virtual keyboard, also referred to as a soft button and/or a soft keyboard. In some arrangements, there may be one display screen 1805 disposed on a front panel of the terminal 1800. In some other arrangements, there may be at least two display screens 1805, respectively disposed on different surfaces of the terminal 1800 or in a folding design. In some other arrangements, the display screen 1805 may be a flexible display screen, disposed on a curved surface or a folded surface of the terminal 1800. In addition, the display screen 1805 may alternatively be set to a non-rectangular irregular pattern, namely, a special-shaped screen. The display screen 1805 may be prepared by using a material such as a liquid crystal display (LCD) or an organic light-emitting diode (OLED).

The camera assembly 1806 may be configured to collect an image or a video. In some arrangements, the camera assembly 1806 may include a front-facing camera and a rear-facing camera. The front-facing camera may be disposed on a front panel of the terminal 1800, and the rear-facing camera may be disposed on a rear surface of the terminal 1800. In some arrangements, there are at least two rear-facing cameras, respectively any one of a main camera, a depth-of-field camera, a wide-angle camera, and a telephoto camera, to implement a background-blur function through fusion of the main camera and the depth-of-field camera, a panoramic photographing function and a virtual reality (VR) photographing function through fusion of the main camera and the wide-angle camera, or another fusion photographing function. In some arrangements, the camera assembly 1806 may further include a flash light. The flash light may be a single-color temperature flash light or a dual-color temperature flash light. The dual-color temperature flash light may refer to a combination of a warm light flash light and a cold light flash light, and may be configured to compensate light at different color temperatures.

The audio circuit 1807 may include a microphone and a speaker. The microphone may be configured to collect sound waves of a user and an environment, and convert the sound waves into electrical signals and input the electrical signals to the processor 1801 for processing, or input the electrical signals to the radio frequency circuit 1804 to implement voice communication. For stereo acquisition or noise reduction, there may be a plurality of microphones, respectively disposed at different parts of the terminal 1800. The microphone may alternatively be an array microphone or an omnidirectional microphone. The speaker may be configured to convert an electrical signal from the processor 1801 or the radio frequency circuit 1804 into a sound wave. The speaker may be a conventional film speaker or a piezoelectric ceramic speaker. When the speaker is a piezoelectric ceramic speaker, the speaker can not only convert an electrical signal into a sound wave audible to a human, but it may also convert an electrical signal into a sound wave inaudible to a human for ranging and another objective. In some arrangements, the audio circuit 1807 may further include a headphone jack.

A person skilled in the art will understand that the structure of shown in FIG. 18 is not limited to the elements and configurations discussed herein; the terminal 1800 may include more or fewer components than those shown in the figure, or some components may be combined, or in different component arrangements.

In some arrangements, the computer device may be provided as a server. FIG. 19 is a schematic diagram of an example structure of a server according to one or more aspects described herein. The server 1900 may vary due to different configurations or performance, and may include one or more central processing units (CPU) 1901 and one or more memories 1902. The memory 1902 may have at least one computer program stored therein. The at least one computer program may be loaded and executed by the processor 1901 to implement the methods described herein. The server may further include components such as a wired or wireless network interface, a keyboard, and an input/output interface, to perform input and output. The server may further include another component configured to implement a device function.

An aspect further provides a computer-readable storage medium. The computer-readable storage medium may have at least one computer program stored therein. The at least one computer program may be loaded and executed by a processor to implement operations performed in the methods for issuing a virtual item described herein.

An aspect of this application further provides a computer program product, including a computer program. The computer program may be loaded and executed by a processor to implement operations performed in the methods for issuing a virtual item described herein. In some arrangements, the computer program involved herein may be deployed in one computer device for execution, or deployed in a plurality of computer devices at one location for execution, or distributed in a plurality of computer devices at a plurality of locations and connected via a communication network. The plurality of computer devices at the plurality of locations and connected via the communication network may form a blockchain system.

A person of ordinary skill in the art will understand that all or some of the operations described herein may be implemented by hardware, or may be implemented by a program instructing related hardware. The program may be stored in a computer-readable storage medium. The storage medium may be a read-only memory, a magnetic disk, an optical disc, or the like.

Optional aspects are described above, and do not constitute a limitation on the configuration and implementations described herein. Any modification, equivalent replacement, and improvement made within the spirit and principle of the aspects described herein are included in the scope of this application.

What is claimed is:

1. A method for issuing a virtual item, performed by a computer device, the method comprising:
determining, by the computer device, whether a target round of an electronic game battle has ended;
in a case that the target round in the electronic game battle has ended, configuring and generating, by the computer device, an item auction interface, the item auction interface comprising a plurality of accounts participating in the electronic game battle and a virtual item that can be used in a subsequent round of the electronic game battle, the plurality of accounts comprising a first account;
determining, by the computer device, whether an auction behavior is unlocked for the first account based on determining whether a battle point ranking of the first account is less than or equal to battle point rankings of a first target quantity of accounts when the plurality of accounts are sorted in an ascending order of battle points, wherein the first target quantity of accounts is a quantity of accounts allowed to participate in an auction;
in a case that the auction behavior is unlocked for the first account, activating, by the computer device, an auction process of the virtual item for the first account based on an auction operation on the virtual item; and
electronically indicating, in a case that it is determined, based on the auction process, that the first account succeeds in the auction, issuance of the virtual item to the first account.

2. The method according to claim 1, wherein the method further comprises:
generating a display, in a preset region corresponding to the virtual item in descending order or ascending order of auction prices, accounts that bid for the virtual item and corresponding auction bid prices, wherein each of the auction prices represents a respective quantity of virtual resources configured for bidding for the virtual item.

3. The method according to claim 1, wherein activating the auction process of the virtual item for the first account based on the auction operation on the virtual item comprises:
in a case that the auction behavior is unlocked for the first account and an auction condition is satisfied, activating the auction process based on the auction operation, wherein the auction condition comprises at least one of the following:
the first account has not successfully bought any virtual item from a beginning of the auction;
the virtual item has not been bought by any of the plurality of accounts from the beginning of the auction;
a status of the virtual item is an in-auction state in a current auction round, wherein the virtual item corresponds to a plurality of auction rounds; and
an auction countdown has not ended, wherein the auction countdown is a time period between a current time point and a time point at which the auction ends.

4. The method according to claim 1, wherein the auction includes a plurality of virtual items, and
wherein the method further comprises, after the indicating of the issuance of the virtual item to the first account:
in a case that all of the plurality of virtual items are bid for, determining that the auction of the plurality of virtual items ends.

5. The method according to claim 1, wherein the auction includes a plurality of virtual items, the plurality of virtual items corresponding to at least one auction round, and
wherein the method further comprises, after electronic issuance of the virtual item to the first account:
in a case that a current quantity of auction rounds of the plurality of virtual items is not less than a second target quantity, determining that the auction of the plurality of virtual items ends, wherein the second target quantity is a maximum quantity of auction rounds of the plurality of virtual items.

6. The method according to claim 1, wherein the auction includes a plurality of virtual items, the plurality of virtual items corresponding to at least one auction round, and
wherein the method further comprises, after the issuance of the virtual item to the first account:
in a case that at least one of the virtual items has not been bid on and a current quantity of auction rounds is less than a second target quantity, activating a next auction round.

7. The method according to claim 1, wherein the method further comprises:
determining a total quantity of virtual resources after the auction of the virtual item ends, wherein the virtual resources are virtual resources corresponding to a total auction price, and the total auction price is an auction price at which the virtual item is successfully purchased; and
generating and displaying a audio or visual effect of the virtual resources, wherein the audio or visual effect of the virtual resources represents that the virtual resources of the total quantity are being issued to the plurality of accounts based on rankings of the battle points of the plurality of accounts.

8. The method according to claim 1, wherein the method further comprises:
generating prompt information on the item auction interface, wherein the prompt information is configured to prompt a first virtual item and a second virtual item, the first virtual item is a virtual item on which the first account is allowed to currently bid, and the second virtual item is a virtual item on which the first account is not allowed currently bid.

9. The method according to claim 1, wherein the auction includes a plurality of virtual items, and the method further comprises:
after the auction of the plurality of virtual items ends, in a case that a virtual item is not bid on and the first account does not successfully purchase any of the virtual items, issuing the not-bid-on virtual item to the first account.

10. The method according to claim 1, wherein the method further comprises:
in response to determining that an auction countdown has ended, and in a case that the virtual item is bid for by one or more of the plurality of accounts, activating an overtime countdown for bidding on the virtual item, wherein the auction countdown is a time period between a current time point and the time point at which the auction ends, wherein
within the overtime countdown of the virtual item, any account that bid for the virtual item is allowed to change a bid price for the virtual item.

11. The method according to claim 10, wherein the method further comprises:
within the overtime countdown of the virtual item, and in a case that any account changes the bid price for the virtual item, resetting the overtime countdown of the virtual item.

12. The method according to claim 1, wherein the method further comprises, before generating the item auction interface, the method further comprises:
in a case that the first account has completed the target round, but another account has not completed the target round, displaying auction prompt information, wherein the auction prompt information is configured to prompt that the auction of the virtual item is about to start.

13. An apparatus comprising:
a processor; and
memory storing computer-readable instructions that, when executed, cause the apparatus to:
determine whether a target round of an electronic game battle has ended;
in a case that the target round in the electronic game battle has ended, configure and generate an item auction interface, the item auction interface comprising a plurality of accounts participating in the electronic game battle and a virtual item that can be used in a subsequent round of the electronic game battle, the plurality of accounts comprising a first account;
determine whether an auction behavior is unlocked for the first account based on determining whether a battle point ranking of the first account is less than or equal to battle point rankings of a first target quantity of accounts when the plurality of accounts are sorted in an ascending order of battle points, wherein the first target quantity of accounts is a quantity of accounts allowed to participate in an auction;
in a case that the auction behavior is unlocked for the first account, activate an auction process of the virtual item for the first account based on an auction operation on the virtual item; and
electronically indicate, in a case that it is determined, based on the auction process, that the first account succeeds in the auction, issuance of the virtual item to the first account.

14. The apparatus according to claim 13, wherein the instructions, when executed, further cause the apparatus to:
generate a display, in a preset region corresponding to the virtual item in descending order or ascending order of auction prices, accounts that bid for the virtual item and corresponding auction bid prices, wherein each of the auction price represents a respective quantity of virtual resources configured for bidding for the virtual item.

15. The apparatus according to claim 13, wherein activating the auction process of the virtual item for the first account based on the auction operation on the virtual item comprises:
in a case that the auction behavior is unlocked for the first account and an auction condition is satisfied, activating the auction process based on the auction operation, wherein the auction condition comprises at least one of the following:
the first account has not successfully bought any virtual item from a beginning of the auction;
the virtual item has not been bought by any of the plurality of accounts from the beginning of the auction;
a status of the virtual item is an in-auction state in a current auction round, wherein the virtual item corresponds to a plurality of auction rounds; and
an auction countdown has not ended, wherein the auction countdown is a time period between a current time point and a time point at which the auction ends.

16. The apparatus according to claim 13, wherein the auction includes a plurality of virtual items, and
wherein the instructions, when executed, further cause the apparatus to, after the electronically indicating of issuance of the virtual item to the first account:
in a case that all of the plurality of virtual items are bid for, determine that the auction of the plurality of virtual items ends.

17. A non-transitory computer-readable medium storing computer-readable instructions that, when executed, cause a computer device providing an electronic game to:
determine whether a target round of an electronic game battle has ended;
in a case that the target round in the electronic game battle has ended, configure and generate an item auction interface, the item auction interface comprising a plurality of accounts participating in the electronic game battle and a virtual item that can be used in a subsequent round of the electronic game battle, the plurality of accounts comprising a first account;
determine whether an auction behavior is unlocked for the first account based on determining whether a battle point ranking of the first account is less than or equal to battle point rankings of a first target quantity of accounts when the plurality of accounts are sorted in an ascending order of battle points, wherein the first target quantity of accounts is a quantity of accounts allowed to participate in an auction;
in a case that the auction behavior is unlocked for the first account, activate an auction process of the virtual item for the first account based on an auction operation on the virtual item; and
electronically indicate, in a case that it is determined, based on the auction process, that the first account succeeds in the auction, issuance of the virtual item to the first account.

18. The non-transitory computer-readable medium according to claim 17, wherein the instructions, when executed, further cause the computer device to:
generate a display, in a preset region corresponding to the virtual item in descending order or ascending order of auction prices, accounts that bid for the virtual item and corresponding auction bid prices, wherein each of the auction price represents a respective quantity of virtual resources configured for bidding for the virtual item.

19. The non-transitory computer-readable medium according to claim 17, wherein activating the auction process of the virtual item for the first account based on the auction operation on the virtual item comprises:
in a case that the auction behavior is unlocked for the first account and an auction condition is satisfied, activating the auction process based on the auction operation, wherein the auction condition comprises at least one of the following:
the first account has not successfully bought any virtual item from a beginning of the auction;
the virtual item has not been bought by any of the plurality of accounts from the beginning of the auction;
a status of the virtual item is an in-auction state in a current auction round, wherein the virtual item corresponds to a plurality of auction rounds; and
an auction countdown has not ended, wherein the auction countdown is a time period between a current time point and a time point at which the auction ends.

20. The non-transitory computer-readable medium according to claim 17, wherein the auction includes a plurality of virtual items, and
wherein the instructions, when executed, further cause the computer device to, after the electronically indicating of issuance of the virtual item to the first account:
in a case that all of the plurality of virtual items are bid for, determine that the auction of the plurality of virtual items ends.
